(19) United States
(12) Patent Application Publication
(10) Pub. No.: US 2015/0142479 A1
(43) Pub. Date: May 21, 2015

(54) Method And System For Drug Prescription

(71) Applicant: doc&i Inc., Northbrook, IL (US)

(72) Inventors: Jeremy Schoeller Porter, Skokie, IL (US); Marc Hilary, Chicago, IL (US); Brad Becker, Northbrook, IL (US)

(21) Appl. No.: 14/539,901

(22) Filed: Nov. 12, 2014

Related U.S. Application Data
(60) Provisional application No. 61/903,173, filed on Nov. 12, 2013.

(51) Int. Cl. G06Q 30/02

(52) U.S. Cl. CPC G06Q 30/0283; G06Q 40/08
USPC 705/4

(57) ABSTRACT

A method and system for estimating the best price for a prescription at a local pharmacy where both the patient and the physician are able to see the best prescription price and location of the pharmacy to make a healthcare choice.

### FIELD OF INVENTION

This invention relates to estimating the price of a drug prescription and, more particularly, a system for estimating the best price of a physician drug prescription and for purchasing the drug prescription at a local pharmacy having a user interface for inputting the patient information and for displaying the best prescription price and pharmacy location.

### BACKGROUND OF THE INVENTION

While the technology has been developed to provide the capability of storing medical records electronically the use and implementation of electronic medical records (“EMR”), has not developed significantly beyond the traditional physician controlled medical record system based only on paper medical records. In fact, most physicians still write paper prescriptions for patient medications to be filled at the pharmacy chosen by the patient. In short, the valuable information contained in the EMR and its automated computer system now required by government regulation is not used to fill or estimate the cost of prescriptions at various know pharmacies in the patient community.

The primary difference between prior art medical information systems and the present invention is the ability of the physician to prescribe medications where both the patient and the physician are able to see the estimated the price of a prescription on a real time basis as a physician enters the medicines that comprise the prescription into an EMR service or an Electronic Prescription (E-Prescribe) service through a handheld or mobile device or a computer terminal via a wireless or wired network connection on an intranet or other secure Internet connection using a standard communication protocol such as the Internet Protocol (TCP/IP), the Hyper Text Transfer Protocol (HTTP). The connection to the system is also possible via an Internet connection to a cloud-based EMR or E-Prescribe service where the system retains the privacy of the patient. A second difference between prior art medical information systems and the present invention is the use of a software application running on a handheld or mobile device interface with the system owned by the patient which contains and communicates information about the patient and patient preferences with the physician, along with providing a mechanism for the patient to store and view their prescription history.

There are a number of prior art patents dealing with medications. For example, U.S. Pat. No. 6,545,592 “Medication reminder device” issued to Weiner, describes a removal prescription vial cap with an embedded electronic unit which generates an alarm alerting the user that it is time to take a dose of his or her medication. Then there is U.S. Pat. No. 7,017,762 “Medication reminder system” issued to Shane, describes a cap or closure for medication bottles which provide indicators for different drugs dispensed by a pharmacist.

Yet another category of prescription compliance inventions are compliance communications systems, which are designed to alert the user of medications to be taken. U.S. Pat. No. 5,850,344 “Medication dispensing and timing system” issued to Conkright, describes a system whereby a central monitoring computer sends medication prompts in accordance with a drug regimen over a two-way paging system to a communicator carried by a patient. U.S. Pat. No. 5,872,505 “Medication alert pager and paging system” issued to Wicks and Sciannnarella, describes a system to assist a patient with treatment reminders whereby patient treatment data is maintained in a database by a paging systems provider and then transmitted to a pager carried by a medical practitioner to remind him or her to administer the treatment in question to the patient.

Still other prior art medical information systems electronically store patient medical records on a database and allows remote access to the records by medical providers and patients. Patients typically control access to their medical record by providing a unique access identification code or means to a system server connected to the database in the physician practice or through the Internet on a cloud storage. Examples of these systems are found in U.S. Pat. Nos. 6,988,075; 7,379,885; 7,412,396; 7,426,476; 7,493,264; 7,593,952; 8,032,397; and 8,209,193 that all show various EMR systems for diagnosing, analyzing and storing patient medical information including elaborate dispensing of pharmaceuticals for nursing home electronic medicine carts. However, none of these prior art patents provide a system for estimating the best price of a prescription or a particular location of a pharmacy in which to purchase the prescription or any alternative medicines such as generic drugs to replace the brand name drugs for the prescriptions. Nor do any of these prior art patents use a software application running on a handheld or mobile device that interfaces with the system that is owned by the patient to store and communicate the patient's information, preferences, and prescription history within the system.

Additionally, by implementing the system of the present invention on the Internet, remote access is provided anywhere with Internet access through a handheld device having a plug-in or add-in application for access to the system servers with no specialized software other than a browser client is required by medical providers to prescribe a particular medication for the selected patient of the physician. Also additional access is available for the system such as the software application running on a handheld or mobile device owned by the patient to provide a convenient and secure mechanism for the patient to communicate their information, preferences, and prescription history to the physician and the device provides a way for the patient to track and manage their own habits and compliance with taking medications prescribed by their physician. Medical providers can include pharmacies, medical laboratories, doctors, hospitals, and nurses that will then have access through the handheld device with the add-in program providing access to the system servers that include a web service responder, a price estimation algorithm server, a medicine database server, an insurance database server, a pharmacy database server and other external data provider servers.

The network utilized by this system of pricing a prescription may comprise: a global communications network, an Intranet, an Internet, a wide area network (WAN), a local area network (LAN), a WI-Fi network, a Bluetooth network, and any combinations of the preceding networks organized in a traditional hierarchical topology, in a point-to-point or in an ad hoc topology (jointly, “Computer Networks”).

The handheld or electronic communications device or user device may comprise: a wired electronic communications device, a wireless electronic communications device, a central processing unit (CPU), a server, a microprocessor, a laptop computer, a desktop computer, an electronic computing device, a computer, an electronic RF device, a cellular (cell) phone, a mobile phone, a smart phone, a qwerty phone, a flip phone, a slider phone, an android phone, a tablet phone, a camera phone, a clamshell device, a portable networking device, a portable gaming device, an electronic communications device, a personal digital assistant (PDA), a wireless e-mail device, a two way pager, an internet communication device, a tablet device, an android tablet, an iPod, an iPad, a Kindle device, an electronic reading device, an electronic photo frame, a digital photo frame, a digital picture frame, a video player, an audio player, an electronic calculator, an electronic monitor, a Blackberry, tablet device, video device, electronic processor, mobile computing device, a computer, a netbook, a notebook computer, a “hybrid” computer, a data sharing device, a wireless device, handheld electronic communications device, a global positioning system (GPS), a web based TV, a navigation device, a transmitting device, an electronic transmitter or receiving device, an electronic planner, a workout planner, an electronic calendar, a scheduling device, a music player, MP3 player, a performance monitor, an incoming call notifier, a statistical storage device, a data storage device, an information storage device, a cadence sensor, a goal setting device, a fitness tracker, an exercise monitor, a sports monitor, a workout frequency monitor, a downloadable device, a Bluetooth compatible device, a data sharing device, a handheld electronic device, a “smart” watch, “smart” glasses, an augmented reality device, a wearable computing device, or any combination of the preceding devices (jointly “User Devices”)

As the Information Age has allowed more and more personal data to be collected, stored, used, and often even sold, privacy concerns of patients have assumed more importance. Many of the prior art electronic medical record systems have included mechanisms to provide some amount of privacy for patients by limiting access to medical records to authorized medical personnel, but have not allowed patients to decide which medical personnel will be authorized. With the present system of estimating the price of a prescription, no patient information such as the patient's social security number or other sensitive medical information about the patient is accessed from the EMR records for transmission over the Intranet or Internet to the system servers for estimating the price of the prescription to comply with government regulations on medical records. So the security of the patient medical records is maintained by the system when the physician enters the prescription into the system of the present invention.

### SUMMARY OF THE INVENTION

Accordingly, the present invention provides a method for estimating the price or the best price that a Patient will pay for a prescription prescribed by a Physician or a plurality of Physicians at a local Pharmacy or a plurality of local Pharmacies or to an Internet Pharmacy to provide that Patient and their Physicians with sufficient information to allow them to cooperatively make an appropriate health care choices. The method consisting of: entering a prescription in a tangible computer medium by a Patient's Physician or a plurality of Physicians; gathering data about the Patient in the tangible computer medium from the Physician's Electronic Medical Records (EMR) system and from a software application running on a Patient User Device; gathering medicine data in the tangible computer medium from a plurality of External Data Providers; gathering insurance provider data in the tangible computer medium from the plurality of External Data Providers; gathering pharmacy data in the tangible computer medium from the plurality of External Data Providers; transmitting the prescription and the Patient data, excluding patient-identifying information, to a computer system; analyzing the prescription and Patient data by the computer system for the cost components and cost offsets; applying an algorithm by the computer system to the cost components and cost offsets of the prescription including Patient data to provide a price estimate the price that the Patient will pay at a Pharmacy or plurality of Pharmacies. As used herein, the term “Patient User Device” is used in its broadest sense to refer to any handheld, mobile, or computing device that is owned or controlled by the Patient and that is able to execute the any embodiment of the Patient software application of the present invention. A brief list of potential Patient User Devices include mobile phones, the iPhone® and other “smart” phones, the iPad® and other Internet-connected tablets, tablet computers, and “personal” laptop or “hybrid” computers.

The present invention describes a system for estimating the price of a prescription to provide the Patient with the opportunity to fill that prescription at the most convenient Pharmacy location or plurality of Pharmacies, whether the Patient deems price, location, or other factors as being most important. The Patient's Physician enters the medicines that comprise that prescription into an EMR system or Electronic Prescription (E-Prescribe) service through the Physician User Device. As used herein, the term “Physician User Device is used in its broadest sense to refer to any handheld, mobile, or computing device that is able to access an EMR or E-Prescribe service via a wireless or wired network connection on an Intranet or the Internet using a standard communication protocol such as the Internet Protocol (TCP/IP), the Hypertext Transfer Protocol (HTTP) and/or other such protocols. The appropriate EMR or E-Prescribe service is installed on the Physician User Device for connection to the Intranet server hosting the patient medical records or via an Internet connection to a cloud-based EMR or E-Prescribe service using standard communication protocols such as TCP/IP, HTTP, or other such protocols, making the Patient medical record information is available to the Physician entering the prescription. A brief list of potential Physician User Devices include mobile phones, the iPhone® and other “smart” phones, the iPad® and other Internet-connected tablets, tablet computers, and “personal” laptop, “hybrid,” and desktop computers.

The system is comprised of two essential components: the System EMR add-in 1 and the System servers 2 as seen in FIG. 1. The System EMR add-in consists of four sub-components: (a) a mechanism or device for interfacing with the EMR or E-Prescribe service to collect information necessary to estimate the price of the prescription; (b) a user interface for presenting the physician with the estimated price of the prescription; (c) a user interface that would allow the physician to substitute lower-priced, equivalent medications or to change the patient's preferred pharmacy; and (d) a mechanism for communicating over a computer network with the System servers. Since there is no standard mechanism to integrate with an EMR service, the EMR interface referred to in the information collection device may consist of web technologies such as HTML and JavaScript that collect information and that overlay System user interface on top of the EMR's user interface. This consists of web technologies such as HTML and JavaScript that use Application Programming Interfaces (“APIs”) defined by the EMR provider to collect information and to inject information into the EMR's user interface. This may also consist of a plug-in made in a computer programming language such as C/C++ or Java that uses APIs defined by the EMR provider to collect information and to inject information into the EMR's user interface. Another interface mechanism with the EMR server may consist of an external program made in a computer programming language such as C/C++ or Java that collects information through one of the EMR's subcomponents such as a database that presents the System user interface independently of the EMR. Additionally, the System user interface may exist independently of the EMR in a standalone software application, requiring the Physician to use tools provided by the Physician User Device, such as copy/paste, to transfer information between the System interface and the EMR

Yet another mechanism or device utilized with the EMR server may consist of an unforeseen interface mechanisms that are provided or required by the EMR server provider or physician in order to maintain compliance with the Health Insurance Portability and Accountability Act (HIPAA) and other relevant privacy regulations.

Additionally, the information collected in user interface mechanism or device may consist of non-patient-identifiable information, including the medicines that make up the prescriptions, the amount of each medicine prescribed, the patient's preferred pharmacy, the patient's prescription insurance provider, and geographic location/coordinates or other information, including patient-identifiable information, as may be necessary to provide an estimate of the prescription or best known cash price of the prescription. Additionally, some or all of the non-patient-identifiable information and patient-identifiable information are provided by the software application running on the Patient User Device, if the transfer of such data is authorized and initiated by the Patient.

The user interface described in sub-component (b) above presents the estimated price of the prescription as computed by the Price Estimation Algorithm server of the System servers 2 in FIG. 1 and as based on the information available via the EMR integration mechanism described in sub-component (a) above. The user interface described in sub-component (c) presents a list of equivalent, alternative medicines to those (or subset thereof) that comprise the prescription, as provided by the Medicine Database 4 that is a subcomponent or hardware element of the System servers 2, along with a list of additional, local pharmacies, as provided by the Pharmacy Database 6 that is also a subcomponent or hardware element of the System servers 2. The estimated price of the prescription at those pharmacies is computed by the Price Estimation Algorithm server 3, a subcomponent or hardware element of the System servers 2 of FIG. 1.

The communication mechanism described in (d) sub-component consists of a web service, such as REST, XML-RPC, JSON-RPC, or SOAP, which uses HTTP commands to allow two or more computer systems or components to communicate and transfer data over a standard web connection. Such data may be in the form of plain text, in the form of a structured textual file such as the JavaScript Object Notation (JSON) or the Extensible Markup Language (XML), in the form of HTML or JavaScript web pages, or in the form of a custom binary file.

The System servers 2 are comprised of six subcomponents: (a) the Web service Responder, which communicates the System EMR add-in by responding to and authenticating web service requests from the System EMR add-in; (b) the Price Estimation Algorithm 3, which computes an estimate of the prescription price based on the information provided by the EMR interface mechanism subcomponent of the System EMR add-in, the Medicine Database 4, the Insurance Database 5, the Pharmacy Database 6, and the External Data Providers 7; (c) the Medicine Database 4, which is a repository of medicines and other relevant information related to the medicine's impact on prescription pricing; (d) the Insurance database 5, which is a repository of the insurance providers and other relevant information related to the insurance provider's impact on prescription prices; (e) the Pharmacy Database 6, which is a repository of pharmacy locations and other relevant information related to the pharmacy's impact on prescription prices; and (f) the External Data Providers 7, which are third party sources of additional information relevant to the price of a prescription. As used herein, the phrase “Database” is used in its broadest sense to refer to any system or mechanism for storing and retrieving information within a computer. A Database in this context may include relational databases (RDBMS), such as Oracle®, MySQL, or PostgreSQL, non-relational data stores (NoSQL), such as MongoDB, CouchDB, or Cassandra, textual search engines, such as Solr, data processing systems, such as Hadoop, plain files, or other mechanisms for storing and retrieving information within a computer. Such information contained in such a Database may be stored in the computer's main memory, on one or more a hard disks, on one or more solid-state or flash disks, or on other relevant computer-based storage systems.

### BRIEF DESCRIPTION OF THE DRAWINGS

FIG. 1 shows a block diagram showing the hardware elements of a system for estimating the price of a prescription in accordance with principles of the present invention.

FIG. 1A shows a block diagram showing the hardware elements of a system for estimating the price of a prescription in accordance with principles of the present invention of FIG. 1.

FIG. 2 shows a process flowchart depicting the steps in a system for estimating the price of a prescription in accordance with present invention of FIG. 1.

FIG. 2A shows a process flowchart depicting the steps in a system for estimating the price of a prescription in accordance with present invention of FIG. 1

FIG. 3 shows a process flowchart depicting the steps in a system for estimating the price of a prescription in accordance with the present invention of FIG. 1.

FIG. 4 shows an example of an EMR display screen with access to a patient medical records in accordance with present invention of FIG. 1.

FIG. 5 shows an example of an EMR display screen with an add-in overlay side-panel with prescription information entered by a physician in accordance with the present invention of FIG. 1.

FIG. 6 shows discloses an example of an EMR display screen with an add-in overlay side-panel with alternate medications, comparison of pharmacies prices and best cash price of the prescribed medication in accordance with the present invention of FIG. 1.

FIG. 7 shows an example of an EMR display screen with an add-in overlay side-panel with patient estimated out of pocket cost for the medication and with confirmation and location of the pharmacy to pick up the prescription in accordance with the present invention of FIG. 1.

FIG. 8 shows a main screen of a standalone application of the system running on a Physician User Device in accordance with the present invention of FIG. 1.

FIG. 9 shows a main screen of a standalone application of the system running on a Physician User Device with information about a prescription entered by the Physician in accordance with the present invention of FIG. 1.

FIG. 10 shows a resulting screen of a standalone application running on the Physician User Device presenting a Patient estimated out-of-pocket cost and providing confirmation and location of the pharmacy to pick up the prescription in accordance with the present invention of FIG. 1.

FIG. 11 shows a resulting screen of a standalone application running on the Physician User Device comparing prices of alternate medications with the best cash price of the prescribed medication in accordance with the present invention of FIG. 1.

FIG. 12 shows a main screen of a standalone application running on the Patient User Device with information about the Patient and their preferences in accordance with the present invention of FIG. 1.

FIG. 13 shows a prescription history screen of a standalone application running on the Patient User Device with information about the Patient prescription history in accordance with the present invention of FIG. 1.

FIG. 14 shows a health information screen of a standalone application running on the Patient User Device with information about the Patient health collected by the Patient entering the information from other applications and from the Patient app interacting with the Physician app during prior visits to the Physician in accordance with the present invention of FIG. 1.

FIG. 15 shows the Physician sharing screen of a standalone application running on the Patient User Device the Patient with the ability to share information with the Physician in accordance with present invention of FIG. 1.

### DETAILED DESCRIPTION OF THE PREFERRED EMBODIMENT

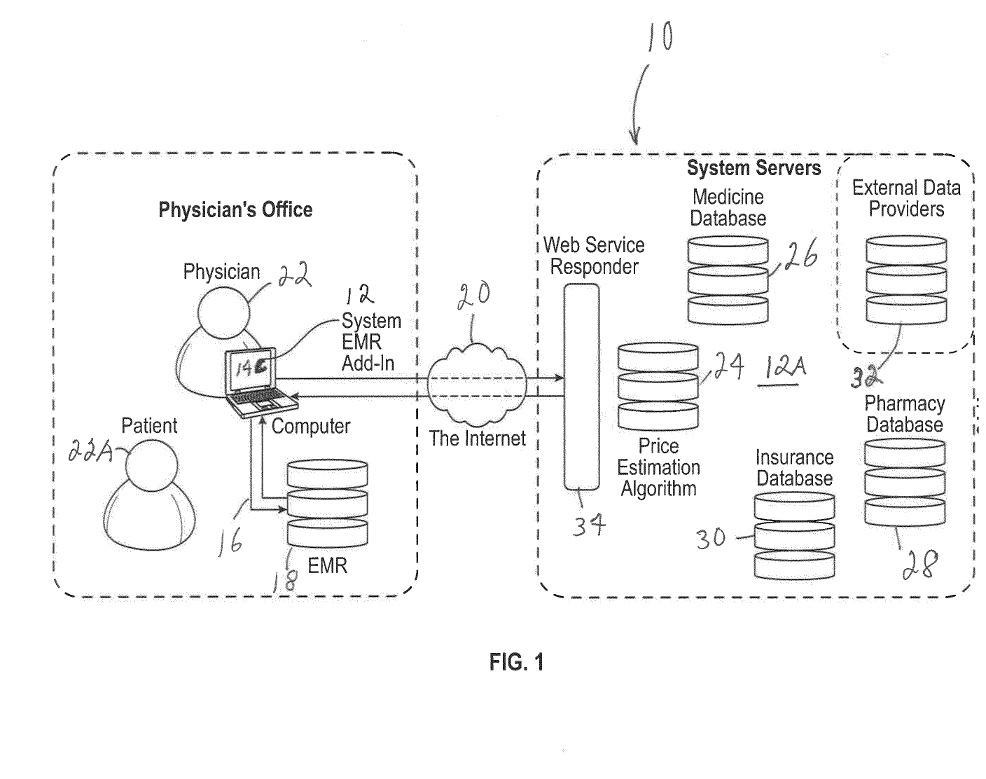

Turning now to FIG. 1, the present invention describes a system for estimating the price of a prescription to provide the Patient with the opportunity to fill that prescription at the most convenient Pharmacy or plurality of Pharmacies, whether the Patient deems price, location, or other factors as being most important. The Patient's Physician enters the medicines that comprise that prescription into an Electronic Medical Records (EMR) system or Electronic Prescription (E-Prescribe) service through a handheld or mobile device or through a computer terminal (jointly “Physician User Devices”). As used herein, the term “Physician User Devices” is used in its broadest sense to refer to any handheld, mobile, or computing device that is able to access an EMR or E-Prescribe service via a wireless or wired network connection on an Intranet or over the Internet using a standard communication protocol such as the Internet Protocol (TCP/IP), the Hypertext Transfer Protocol (HTTP) and/or other such protocols. The appropriate EMR or E-Prescribe service is installed on the Physician User Device for connection to the Intranet server hosting the patient medical records or via an Internet connection to a cloud-based EMR or E-Prescribe service using standard communication protocols such as TCP/IP, HTTP, or other such protocols, the patient medical record information is available to the physician entering the prescription. A brief list of potential Physician User Devices include mobile phones, the iPhone® and other “smart” phones, the iPad® and other Internet-connected tablets, tablet computers, and “personal” desktop, laptop, and “hybrid” computers.

As shown in FIG. 1, a system 10 is comprised of two components: a System EMR add-in 12 and System Servers 12A. The System EMR add-in 12 consists of four sub-components or hardware elements: (a) a mechanism 16 for interfacing with an EMR 18 or E-Prescribe service to collect information necessary to estimate the price of the prescription; (b) a user interface 14 for presenting the physician with the estimated price of the prescription; (c) the user interface 14 that allows the physician to substitute lower-priced, equivalent medications or to change a patient preferred pharmacy; and (d) a mechanism 20 for communicating over a computer network with the System servers. Since there is no standard mechanism or device to integrate with the EMR service 18, the EMR interface 16 referred to in sub-component (a) may consist of web technologies such as HTML and JavaScript that collect information and then overlay the System user interface 14 on top of the EMR user interface 16. Sub-component (a) may consist of web technologies such as HTML and JavaScript that use Application Programming Interfaces (APIs) defined by the EMR provider to collect information and to inject information into the EMR's user interface 16. Sub-component (a) may consist of a plug-in made in a computer programming language such as C/C++ or Java that uses APIs defined by the EMR provider to collect information and to inject information into the EMR's user interface. Sub-component (a) may consist of an external program made in a computer programming language such as C/C++ or Java that collects information through one of the EMR's subcomponents, such as a database, and then presents the System user interface independently of the EMR 18. The sub-component (a) may consist of an unforeseen interface mechanisms 16 that are provided or required by the EMR provider or a physician 22 in order to maintain compliance with the Health Insurance Portability and Accountability Act (HIPAA) and other relevant privacy regulations. All of the above listed subcomponents or hardware elements are incorporated into the handheld wireless device or user device 14.

Additionally, the information collected in a sub-component consists of non-patient-identifiable information, including the medicines that make up the prescriptions, the amount of each medicine prescribed, the Patient's preferred pharmacy, the Patient's prescription insurance provider, and geographic location or coordinates or other information, including patient-identifiable information, as may be necessary to provide an estimate of the price of the prescription and to determine the most convenient pharmacy or plurality of pharmacies to fill the prescription. Next, the Patient and Physician are able to track and manage a history of the Patient's prescriptions and the Pharmacies where those prescriptions were filled.

The user interface device 14 described as incorporating the sub-component (b) drives a display screen 14A on the device 14 to present a visual display to the physician of the estimated price of the prescription as computed by a Price Estimation Algorithm server 24. The Algorithm server 24 includes a set of instructions to integrate the information from other database servers within the System servers 12A into the computation of the final price of the prescription as based upon the information available via the EMR integration mechanism described in sub-component (a) of the System add-in 12. The display screen of the user interface device 14 with the described with the sub-component or hardware element (c) presents a visual list of equivalent, alternative medicines to those (or subset thereof) that comprise the prescription, as provided by a Medicine Database server 26 that is another subcomponent of the System servers 12A, along with a list of additional, local pharmacies, as provided by a Pharmacy Database server 28 which is also a subcomponent of the System servers 12A, and the estimated price of the prescription at those pharmacies, as computed by the Price Estimation Algorithm server 24, a subcomponent of the System servers 12A.

The communication mechanism described in sub-component (d) of the System add-in 12 consists of a web service, such as REST, XML-RPC, JSON-RPC, or SOAP, which uses HTTP commands to allow two or more computer systems or components to communicate and transfer data over a standard web connection. Such data may be in the form of plain text, in the form of a structured textual file such as the JavaScript Object Notation (JSON) or the Extensible Markup Language (XML), in the form of HTML or JavaScript web pages, or in the form of a custom binary file.

The System servers 12A are comprised of six subcomponents: (a) the Web service Responder 8a subcomponent, which communicates with the System EMR add-in 12 by responding to and authenticating web service requests from the System EMR add-in 12; (b) the Price Estimation Algorithm server 24 subcomponent, which computes an estimate of the prescription price based on the information provided by the EMR interface mechanism 16 subcomponent of the System EMR add-in 12, (c) the Medicine Database server 26 subcomponent, (d) an Insurance Database server 30 subcomponent, (e) the Pharmacy Database server 28 subcomponent, and (f) an External Data Providers server 32 subcomponent.

The (c) Medicine Database server 26, which is a repository of medicines and other relevant information related to the medicine's impact on prescription pricing; (d) the Insurance database 30, which is a repository of the insurance providers and other relevant information related to the insurance provider's impact on prescription prices; (e) the Pharmacy Database 28, which is a repository of pharmacy locations and other relevant information related to the pharmacy's impact on prescription prices; and (f) the External Data Providers 32, which are third party sources of additional information relevant to the price of a prescription, are all hardware servers required for the system 10 to provide the estimated or final pricing for the prescription.

As used herein, the phrase “Database” is used in its broadest sense to refer to any system or mechanism for storing and retrieving information within a computer. A Database in this context may include relational databases (RDBMS), such as Oracle®, MySQL, or PostgreSQL, non-relational data stores (NoSQL), such as MongoDB, CouchDB, or Cassandra, textual search engines, such as Solr, data processing systems, such as Hadoop, plain files, or other mechanisms for storing and retrieving information within a computer.

The information contained in any of the above described Databases may be stored in the computer's main memory, on one or more a hard disks, on one or more solid-state or flash disks, or on other relevant computer-based storage systems. Additionally, any Databases that comprise the system may be, in practice, combined into a single, unified database system of any type; may be maintained in individual database system of the same or varying types; or may be combined into any combination of Databases of any type that result in more than one database system but fewer database systems than if such Databases were maintained individually.

The Web service Responder 34 described in (a) subcomponent consists of a web server, such as Apache, Tomcat, or WebSphere, configured to automatically authenticate and respond to web service requests from the System EMR add-in 12. Such authentication may be performed using the IP addresses of the Physician User Device 14 making the request; by the physician 22 entering a username and password; through the use of security tokens, certificates, or signatures provided independently of EMR add-in 12 and installed onto the Physician User Device 14 by the administrator of the Physician User Device 14, by any combination of these mechanisms, or by other methods recognized as best-practices for computer security.

The Price Estimation Algorithm server 24 as described in (b) subcomponent is a mathematical algorithm with program instructions for estimating the price of a prescription based on the medicines that comprise that prescription identifying the medications making up the prescription. The algorithm incorporates retail pricing data from pharmacies, data from the Patient's health insurance plan, retail pricing data from drug manufacturers, data from the Patient's drug card plans, data from pharmacy benefit managers, and other sources of data that describe the actual price, the advertised price, the suggested price, or a price offsets for a medicine or plurality of medicines. The algorithm uses any such data to the system at the time the price estimate is computed by the algorithm, recognizing that such data may not be available for all medicines, for all patients, in all circumstances, or even for different price estimate computations run for the same medicines for the same patient under similar circumstances at a later time or date. The algorithm also incorporates various methods of estimating current and future prescription prices for groups of patients with similar characteristics, when the exact price cannot be determined either due to a lack of sufficient data about the current actual price of the medicine(s) that comprise the prescription or due to a lack of specific information about the Patient, such as the Patient's specific insurance plan. The methods used by the algorithm may include selecting a representative medicine from similar drug classes, simple arithmetic means and weighted arithmetic means, linear and non-linear regression models, random walk methods, cluster analysis methods, machine learning methods, and other statistical, iterative, and direct methods that represent best practice and the state of the art in predictive analysis. The algorithm additionally incorporates various methods of estimating the convenience to the Patient in filling the prescription, including the Patient's exact or approximate location, the exact location of pharmacies in the Patient's geographic area, the Patient's preferred pharmacy or pharmacies, the Patient's preferred time of day to fill the prescription, the current automotive traffic volume on the roads in the Patient's geographic area, and other factors relevant to Patient convenience in filling prescriptions. If the Patient's prescription consists of multiple medications to be filled at multiple pharmacies, the algorithm may also compute the optimal rout to travel to each pharmacy. Next, the program in server 3 includes the formulary of the patient's insurance plan, the retail prices at the patient's preferred pharmacy, the estimated prices of equivalent, alternative medications, historical prices for the medicines that comprise the prescription and other factors.

The Medicine Database server 26 described in (c) subcomponent contains information specifically related to the characteristics of medicines and may include the medicine's brand name, its generic name, its drug class, its mechanism of action, equivalent alternatives for that medicine, its MSRP, and other relevant information. The data contained in the Medicine Database may represent data about medicines or a plurality of medicines from a single point in time, an irregular collection of data over a period of time, a regularly collected time-series, or any combination of these.

The Insurance Database server 30 described in (d) subcomponent contains information specifically related to insurance providers and may include the provider's legal name, common names, registered address, insurance plan names, insurance plan descriptors, prescription drug riders, plans, and formularies, preferred drug lists, and other relevant information. The data contained in the Insurance Database may represent data about insurance providers or a plurality of insurance providers from a single point in time, an irregular collection of data over a period of time, a regularly collected time-series, or any combination of these.

The Pharmacy Database 28 described in (e) subcomponent contains information specifically related to the pharmacies, dispensaries, and other businesses and individuals licensed to fill prescriptions and dispense medicines. The pharmacy information generally includes the pharmacy legal name, common names, registered address, retail prices, prices within a given insurance plan, and other relevant information to compute the best price for the medicines in the prescription. The data contained in the Pharmacy Database may represent data about pharmacies or a plurality of pharmacies from a single point in time, an irregular collection of data over a period of time, a regularly collected time-series, or any combination of these.

The External Data Provider servers 32 described in (f) subcomponent consist of third-party sources of information related to the pricing of prescriptions for which the information resides within data storage systems own and managed by the provider and for which the System server 12A accesses any such information through defined APIs belonging to the Providers. The External Data Provider servers 32 consist of the United States Food and Drug Administration (FDA), pharmaceutical companies, insurance providers, insurance and pharmaceutical clearinghouses, hospital networks and other medical practices, and other such relevant data providers. The data collected from External Data Providers may represent a single point in time, an irregular collection of data over a period of time, a regularly collected time-series, or any combination of these.

The present invention includes a software application installed by the Patient on a handheld device, mobile, device, or portable computer owned and controlled by the Patient (jointly “Patient User Devices”). As used herein, the term “Patient User Device” is used in its broadest sense to refer to any handheld, mobile, or computing device that is owned and controlled by the Patient and that is able to execute the any embodiment of the Patient software application of the present invention. A brief list of potential Patient User Devices include mobile phones, the iPhone® and other “smart” phones, the iPad® and other Internet-connected tablets, tablet computers, and “personal” laptop or “hybrid” computers. This software application provides a mechanism for the Patient to enter and security communicate non-patient-identifiable information, patient-identifiable information, preferences, the prescription history, and other information with their Physician and allows the Patient to track and manage their adherence to the Physician prescribed drug course. The software application consists of an user interface, a mechanism for collecting authorized information from the Patient User Device and other software applications installed on the Patient User Device, an internal database for storing the Patient data, a mechanism for user authentication, a mechanism for communicating over Computer Networks with the software add-in for the Physician EMR, and a mechanism for communicating of Computer Networks with External Data Providers. The software application user interface allows the Patient to enter and update their information, such as their home address, to view all Patient data, and to authorize and initiate data transfer. The software application can interface with the Patient User Device to automatically collect certain information, such as the device's current GPS coordinates, from the Patient User Device. Additionally, the software application can interface with other applications installed on the Patient User Device and authorized by the Patient to collect additional health-related information, such as the Apple Health App on the iPhone The database in this context may include relational databases (RDBMS), such as Oracle®, MySQL, or PostgreSQL, non-relational data stores (NoSQL), such as MongoDB, CouchDB, or Cassandra, textual search engines, such as Solr, data processing systems, such as Hadoop, plain files, or other mechanisms for storing and retrieving information within a computer. The mechanism for user authentication may consist of username and password, interfacing with mechanisms on the Patient User Device, such as Apple TouchID, and other methods considered industry best-practice for authentication. The mechanism for communicating over Computer Networks consists of using standard communication protocols such as TCP/IP, HTTP, or other such protocols to access the Internet or to create an ad-hoc network with Physician User Device and using industry best-practice encryption and session management to secure the connection.

In another embodiment of the system, certain applications and services are provided to the patient including a web interface and Physician User Device 14 with installed program applications in the System add-in 12 to interface with the System servers 12A for comparing the cash price and price under the patient's insurance plan for prescriptions and individual medications. Another add-in program would be for comparing such prices between various pharmacies close to the patient, which is often more important to the patient than just the lowest price as a convenient location in proximity to the patient saves time and effort in procuring the medicines in the prescription. Then there are a host of other applications available for notifying the patient when an ongoing prescription has a lower price at a pharmacy different than their preferred pharmacy or for submitting ongoing prescriptions for refill from within the system or for comparing the prices of the individual medicines within a prescription between various pharmacies close to the patient or for submitting a composite prescription whereby any of the individual medicines within and for other related services.

### DETAILED DESCRIPTION OF THE PHYSICIAN FLOWCHART

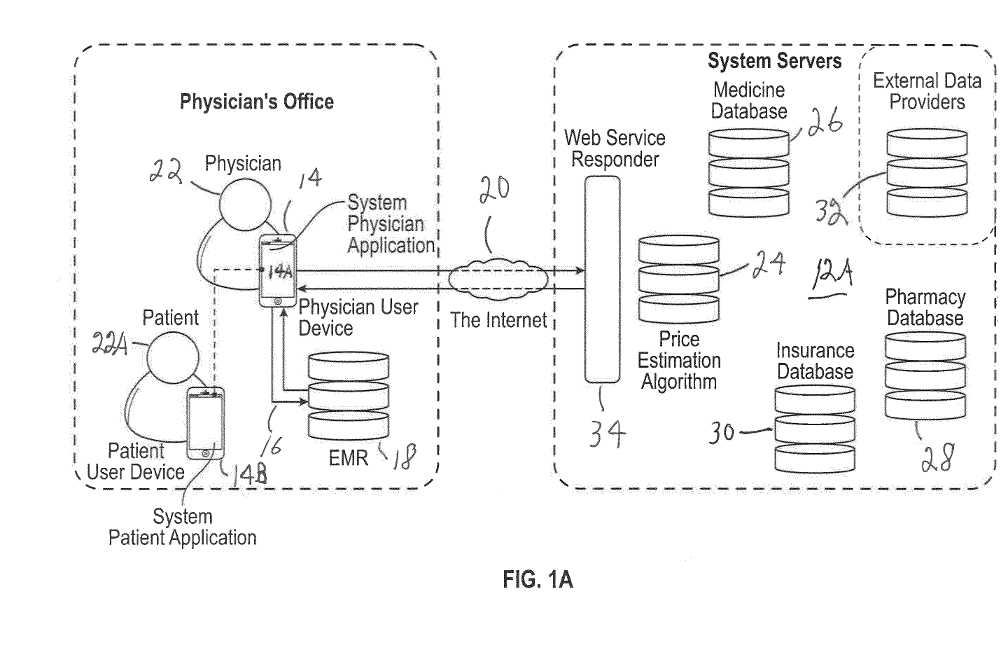

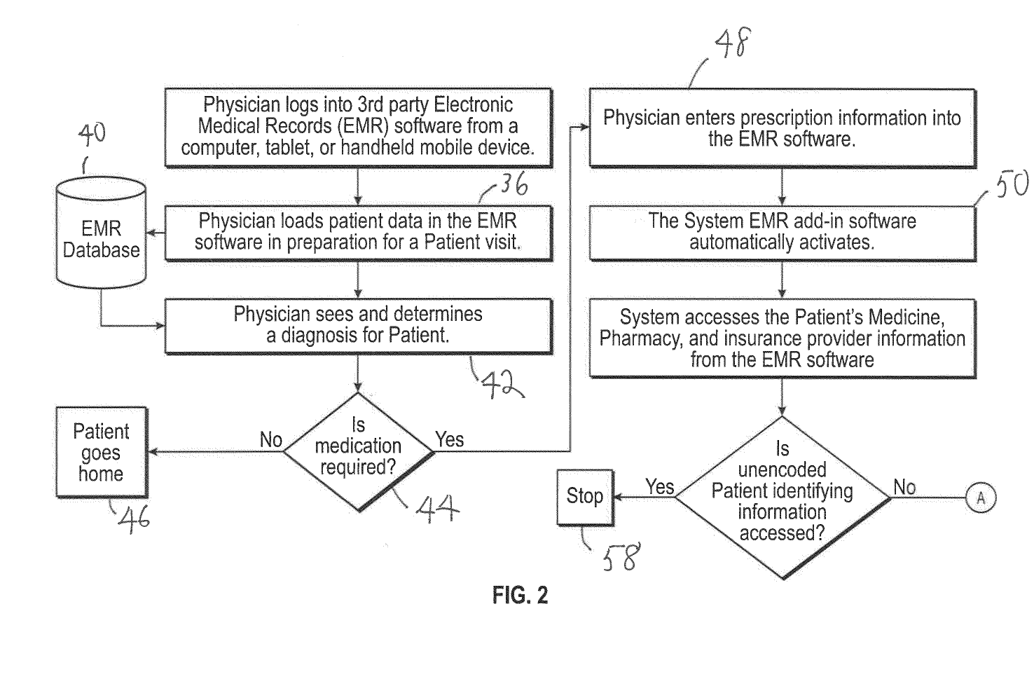

FIGS. 2 and 3 are flowcharts that describe the use of the system by a physician while prescribing medication to treat a patient. Depending on the Physician User Device 14, the physician may or may not be in the examination room and the patient may or may not be present at the time the prescription is written by the physician. The method of using the present invention estimation of prescription prices involves the following steps as outlined below.

In a first step found in decision block 10 in FIG. 2, the physician logs onto the EMR service 18 on the Physician User Device 14 (a computer, tablet or handheld mobile device) using the normal procedures and security protocols including password protection in place at the physician practice or if 14 wireless Physician User Device 14 is used by the physician with the appropriate security protection, the physician can log onto the Internet in any Wi-Fi hotspot or even through a home computer or router connected to the Internet.

In a second step, a decision block 36, the physician loads the patient's data retrieved from the EMR service 40 onto the Physician User Device 14. Depending on the EMR service 40, the Physician User Device 14, and the policies of the physician's place of practice the patient data may or may not be physically resident on the Physician User Device 14. For privacy reasons, the patient confidential data such as the social security number and other medical problems and diseases are often not downloaded onto the Physician User Device 14 unless the Physician User Device 14 is only connected to the Intranet within the physician office or unless that data is provided to the Physician by a Patient 22A using the software application on the Patient User Device 14B

In a third step, a decision block 42, the physician examines the patient and determines if any prescription medication is necessary according to a decision block 44. If the physician determines that prescription medication is not necessary, the service is not used, decision block 46, and the physician 22 and patient 22A end the visit and the patient goes home following the normal procedures for the physician's place of practice.

If the physician 22 determines that prescription medication is necessary in the decision block 44, then in a fourth step 48, the physician then enters the medication and prescription details into the EMR system 40 in decision block 48 using the normal procedures at the physician's place of practice.

In a fifth step, a decision block 50, the System EMR add-in 12 automatically detects that the physician 22 entered prescription medication information into the EMR service 40 and initiates a connection with and authenticates in a decision block 52 within the System servers 12A.

In a sixth step, a decision block 54, the System EMR add-in 12 automatically collects the information necessary to estimate the price of the prescription at the Patient's preferred pharmacy, and the data is checked to ensure that no patient-identifying information has been accessed in decision block 56. If patient-identifying information or private medical records of a condition are present then in decision block 58, the System EMR add-in 12 raises an alert, releases any information collected in the hardware memory of the Physician User Device 14, and the Physician User Device 14 does not send any prescription or private information to the System servers 12A.

In a seventh step, a decision block 60, when no patient identifying or private information is present, the System EMR add-in 12 transfers the prescription information that it collects to the Web Service Responder 34 in the System servers 12A.

In an eighth step, a decision block 62, the Web service Responder 34 subcomponent of the System servers 12A receives the information transferred by the System EMR add-in 12 and passes the data to the Price Estimation Algorithm server 24 subcomponent.

In a ninth step, a decision block 64, the Price Estimation Algorithm server 24 subcomponent of the System servers 12A performs lookups in the Medicine Database server 26 subcomponent, the Insurance Database server 30 subcomponent, the Pharmacy Database server 28 subcomponent, and any appropriate External Data Provider servers 32 for additional information to compute the estimated price of the prescription. If a lookup in one of the Databases fails, in decision blocks 66/68, then the Price Estimation Algorithm server 24 releases the information provided by the System EMR add-in 12, the System servers 12A return an error condition in a decision block 70 to the System EMR add-in 12, and the System EMR add-in 12 raises an alert and releases any information it has collected in a memory storage unit on the physical User Device 14.

In a tenth step, a decision block 72, the System servers 12A compute the estimated price of the prescription at the patient's preferred pharmacy; determines equivalent or alternative medications; computes estimated prices at other pharmacies in the patient's local area; and then transfers the computed information logic block 74 to the System EMR add-in 12 for display on the display screen 14A.

In an eleventh step, a decision block 76, the System EMR add-in 12 presents the estimated price of the prescription at the patient's preferred pharmacy to the physician and displays on the display screen of the Physician User Device 14 or a user interface element within the EMR service 40 to present the prices of the equivalent, alternative medications and the estimated price of the prescription at alternative pharmacies to the physician.

In a twelfth step, a decision block 78, the physician and the patient discuss the estimated price of the prescription provided by the system and determine if any changes are necessary and in a decision block 80, the physician and patient discuss prescription and costs thereto. If the cost of the prescription is prohibitive for the patient then the physician makes changes to the prescription with the EMR service 40 using the normal process of the utilizing the handheld Physician User Device 14 at the physician place of practice. The System EMR add-in 12 automatically detects any changes by the physician in the prescription and the process restarts at step (7) in the decision block 60. If no changes are necessary, then the physician and patient end the visit following the normal procedures for the physician's place of practice. Additionally, the prescription information may be transmitted to the software application on the Patient User Device.

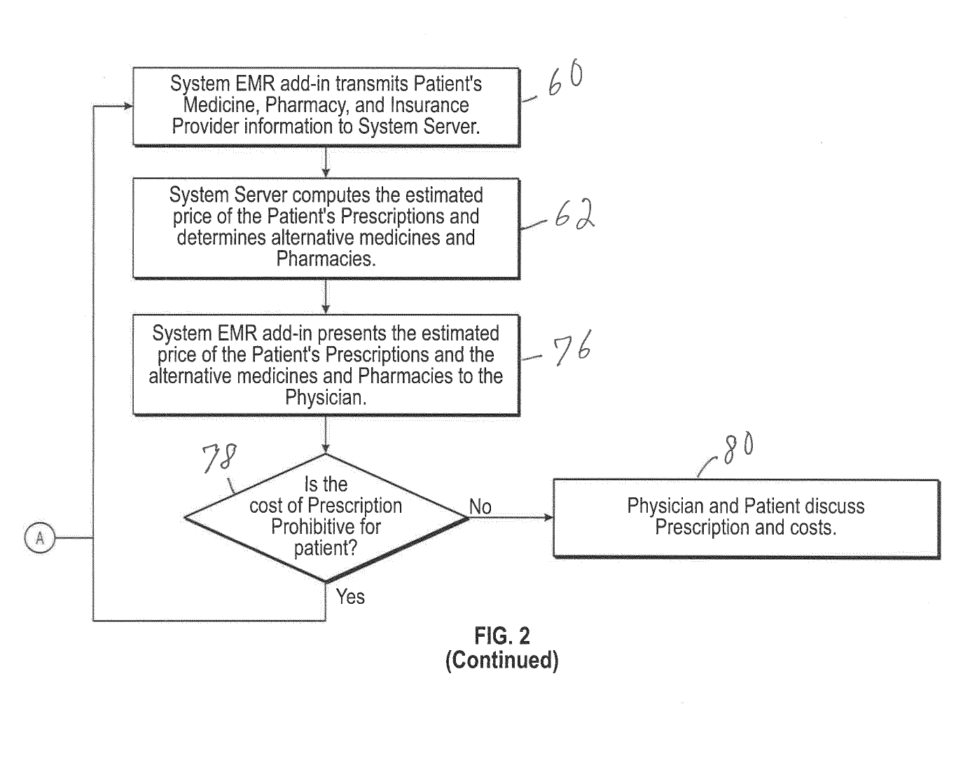

Turning now to FIG. 4, this a display of a screen shot 82 from the EMR system 40, which shows the patient name with vital statistics and Primary Insurance carrier for the insured patient. The physician receives this screen shot on the handheld wireless or wired Physician User Device 14 for ordering the particular prescription of interest.

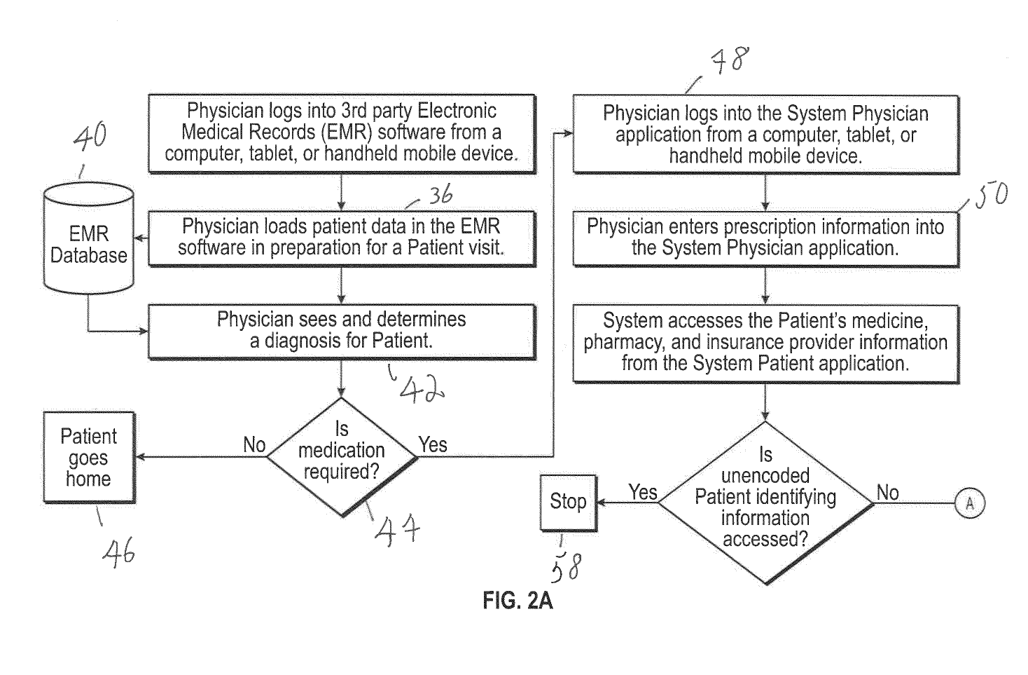

FIG. 5 depicts the overlay EMR add-in 12 side panel 84 in the display of the Physician User Device 14 with the EMR screen shot 82 behind the side-panel 84. The information on this side-panel 84 contains no identifying information about the patient or any private information whatsoever for privacy reasons. Just the treating physician provider name and the prescribed medicine(s) and date along with the dosage amounts are shown on this EMR add-in 12 display 14C also on the Physician User Device 14 display screen 14A. However, the provider or physician can see the name of the patient being prescribed on the EMR screen shot display 82 behind the side-panel 84 in case the physician was distracted with some other task and had to come back to his handheld device or computer, the patient being prescribed is readily identifiable.

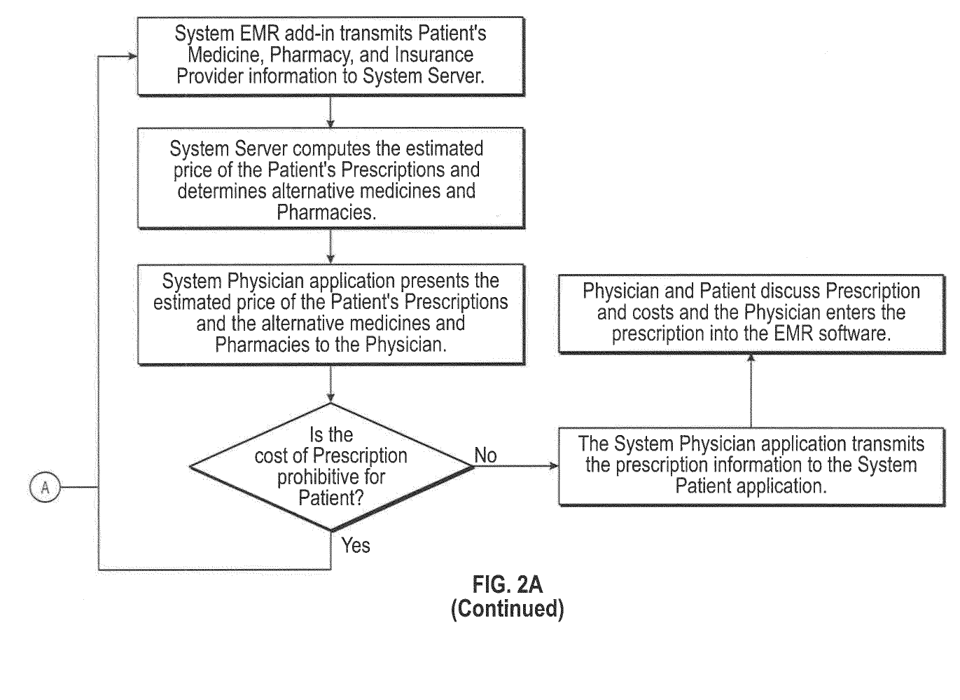

FIG. 6 depicts a side-panel 86 that is at the heart of the System 10 that shows the Pharmaceutical Pricing Engine and the web address of http://www.docandi.com being accessed by the physician during the entering of the prescription into the system hardware. The side-panel display shows the Alternate Medications, compares the available pharmacies in the patient area with addresses and then lists the best cash price for the prescription with the dosage and the price per dosage.

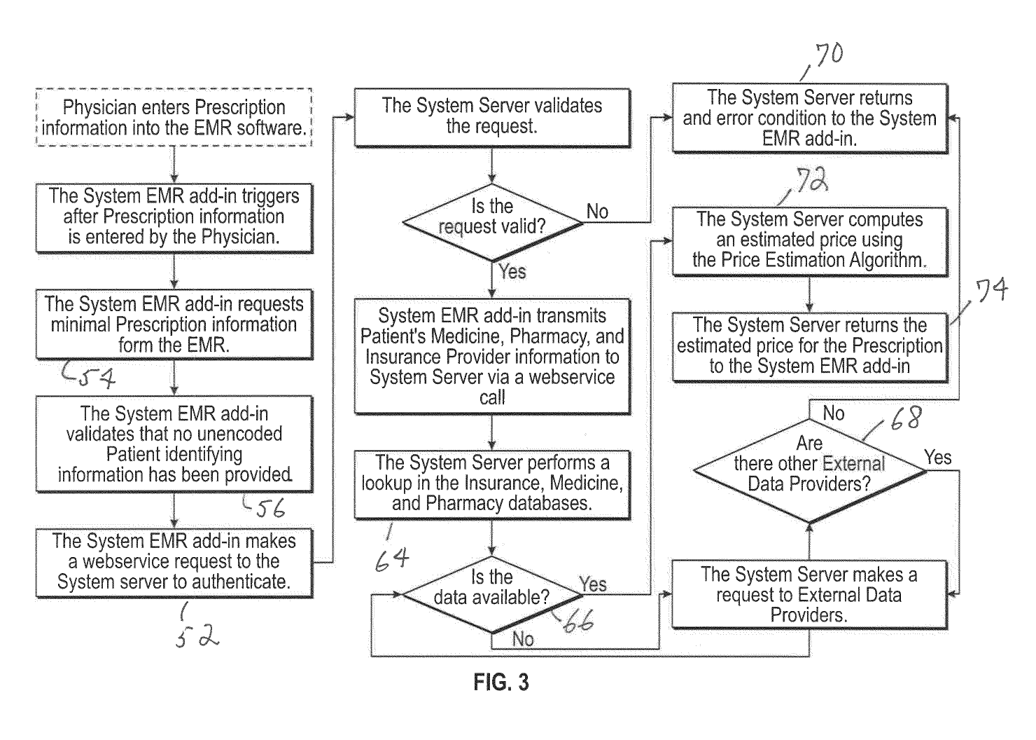

FIG. 7 depicts what the patient estimated out of pocket cost for the medicines that are prescribed on a separate overlay display 88 and also shows on a side-panel overlay 90, which gives the location of the pharmacy of choice with map directions and the ability to either confirm the prescription or cancel the prescription that will be sent to the pharmacy if the prescription cost is in-line with the decision of the patient and the physician. Information about the acceptance of the assignment by the insurance company is clearly displayed on the main EMR display screen 82 below the side-panel overlay 84.

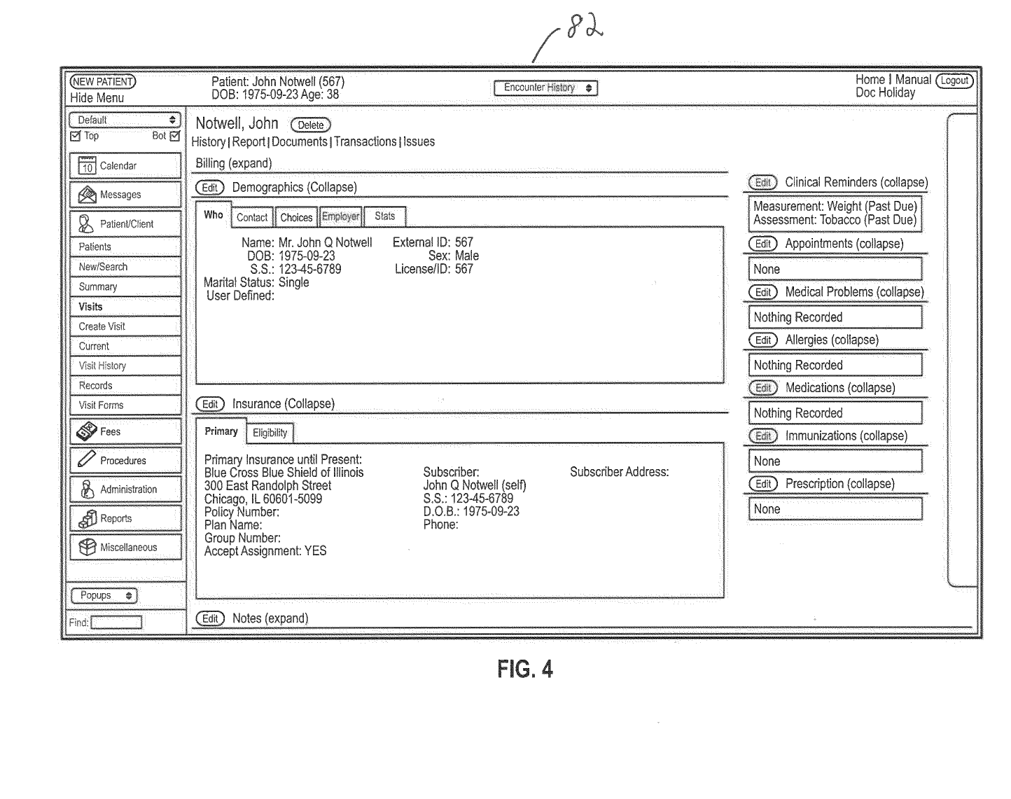

FIG. 8 discloses an example of the main screen of a standalone application running on the Physician User Device 14 in accordance with present invention of FIG. 1. Here the System Screen includes the drug, its strength in MG and the count of pills, cost of drugs and preferred pharmacy.

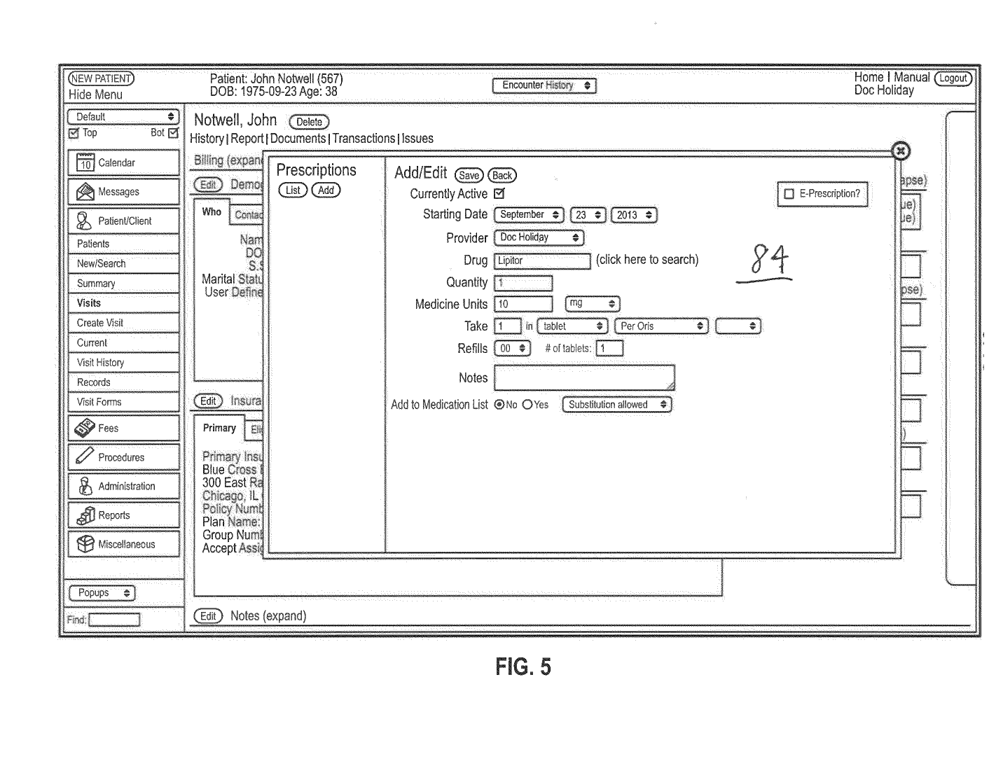

FIG. 9 shows an example of the main screen of a standalone application running on the Physician User Device with information about a prescription entered by the Physician in accordance with present invention of FIG. 1.

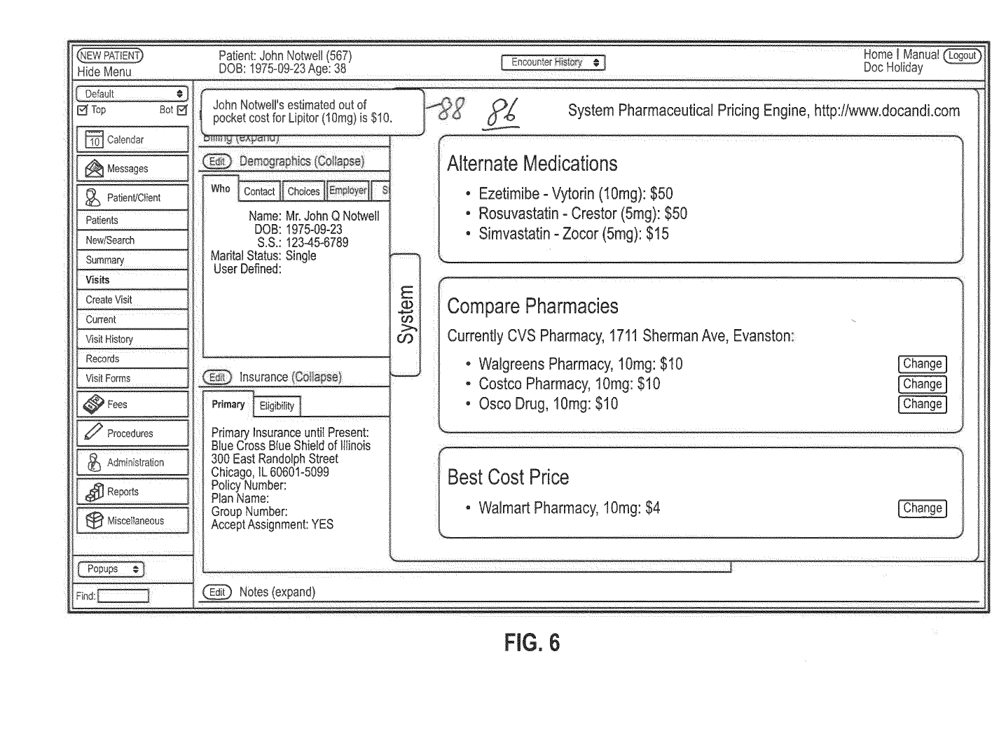

FIG. 10 shows an example of the result screen of a standalone application running on the Physician User Device 14 presenting the Patient's estimated out of pocket costs for the medication at several different pharmacies and providing confirmation and locations of several pharmacies to pick up the prescription in accordance with the present invention of FIG. 1.

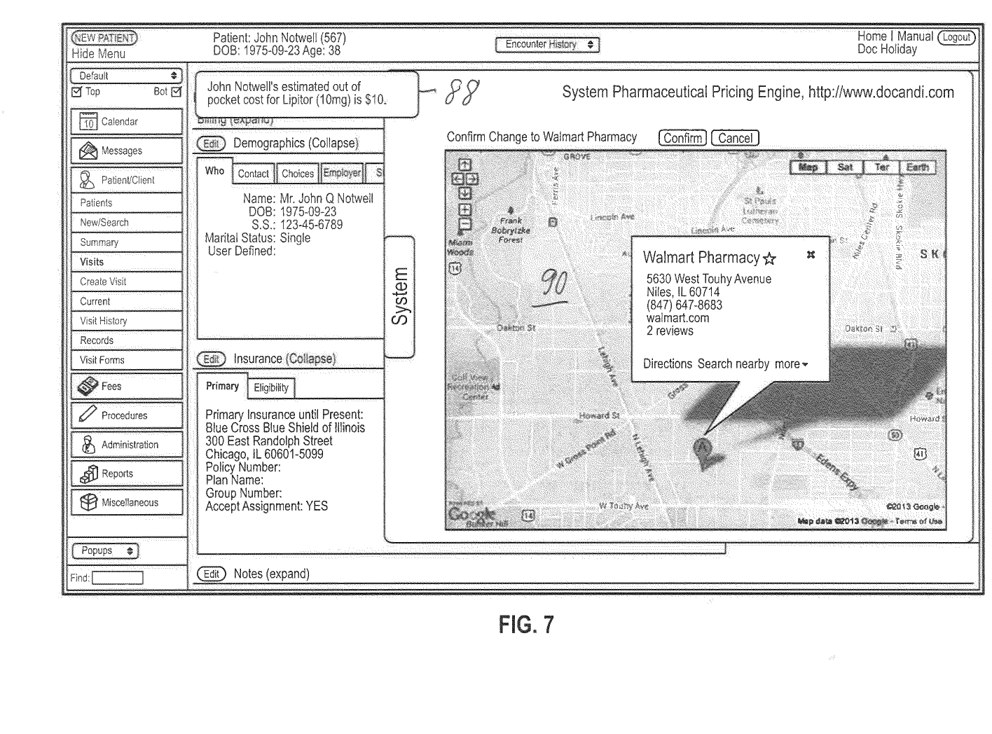

FIG. 11 shows an example of the result screen of a standalone application running on the Physician User Device 14 comparison of the price of alternate medications with the best cash price of the prescribed medication at several local pharmacies in accordance with the present invention of FIG. 1.

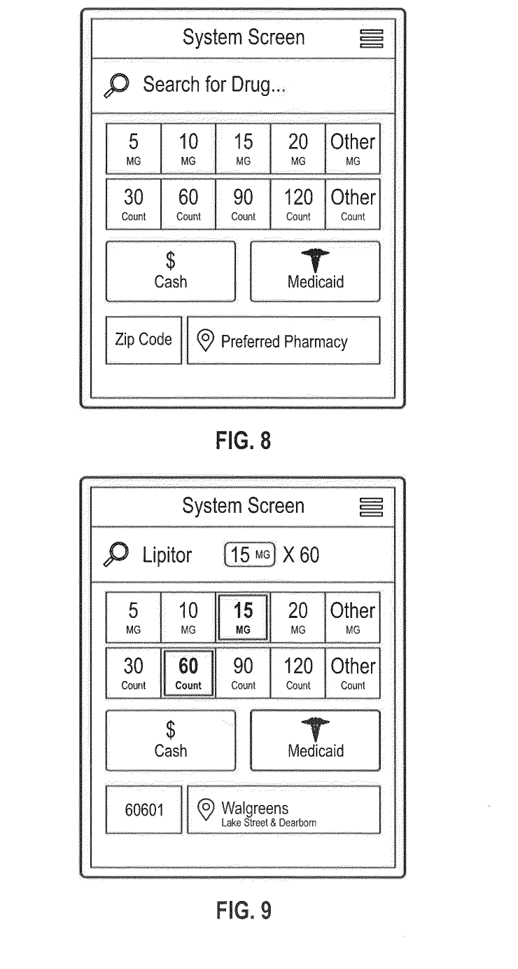

FIG. 12 shows an example of the main screen of a standalone application running on the Patient User Device 14 with information about the Patient including the prescription history, health information and their preferences in accordance with present invention of FIG. 1.

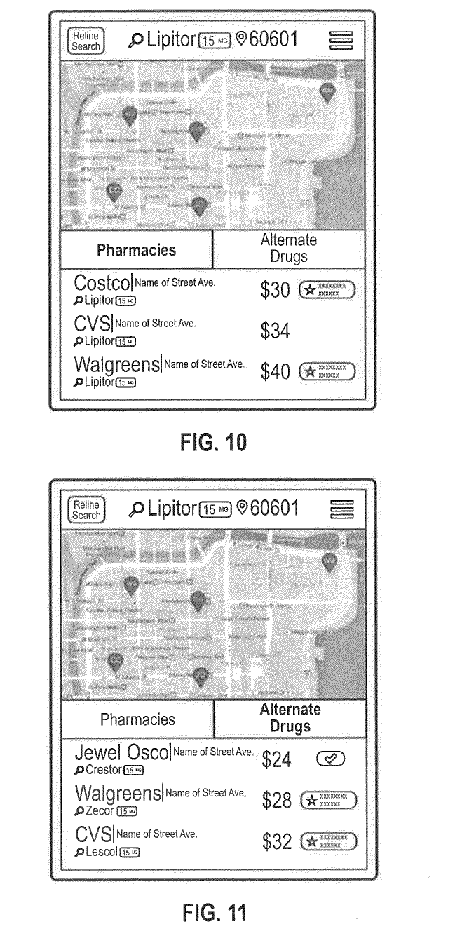

FIG. 13 shows an example of the prescription history screen of a standalone application running on the Patient User Device 14 with information about the Patient's prescription history in accordance with present invention of FIG. 1

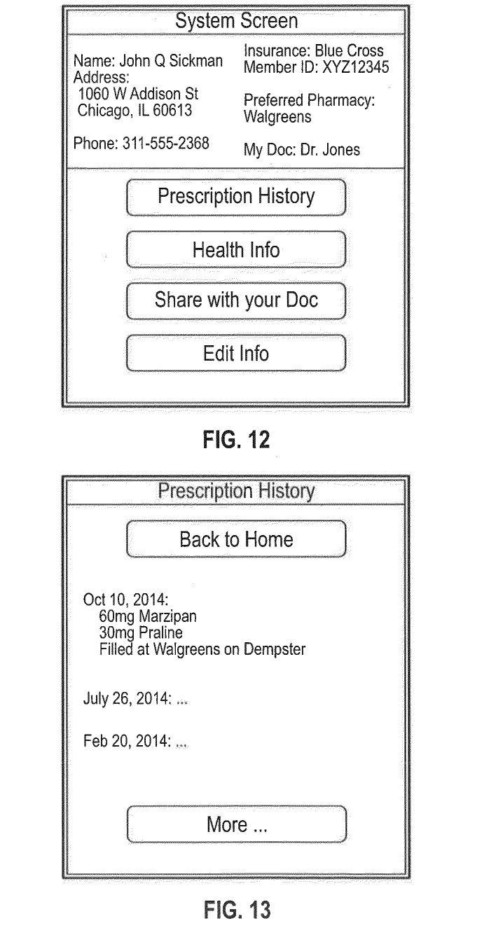

FIG. 14 shows an example of the health information screen of a standalone application running on the Patient User Device 14B with information about the Patient's health collected by the Patient entering the information, from other applications, and from the Patient app interacting with the Physician app during other visits to the Physician in accordance with present invention of FIG. 1.

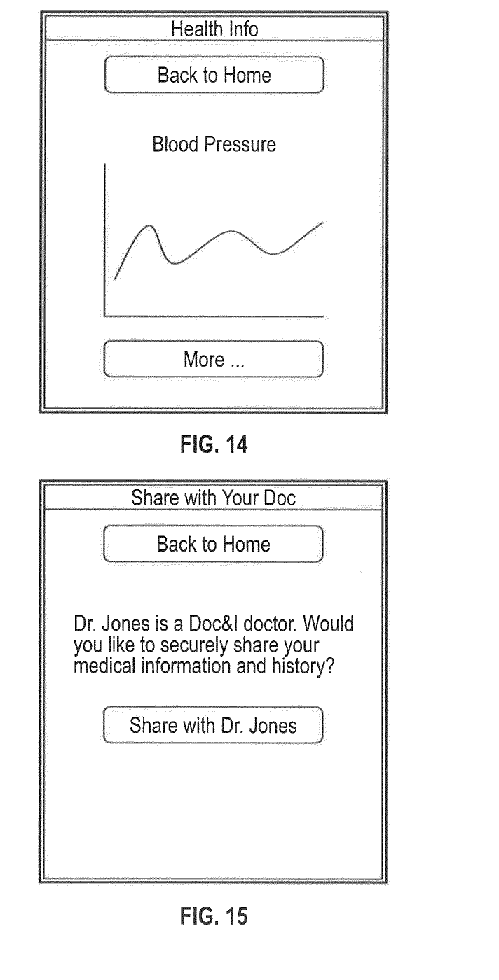

FIG. 15 shows an example of the Physician sharing screen 14A of a standalone application running on the Patient User Device 14B the Patient with the ability to share information with the Physician in accordance with present invention of FIG. 1.

While the description above refers to particular embodiments of the present invention, it will be understood that many modifications may be made without departing from the spirit thereof. The accompanying claims are intended to cover such modifications as would fall within the true scope and spirit of the present invention. The disclosed embodiments are therefore to be considered as illustrative and not as restrictive. The scope of the invention is defined by the appended claims.

Having thus described the invention, we claim:

1. A method for estimating a best price Physician prescription at a local Patient Pharmacy, comprising:
a. gathering the prescription in a tangible computer medium from a Physician;
b. gathering data about a Patient in the tangible computer medium;
c. gathering medicine data in the tangible computer medium from a plurality of External Data Providers;
d. gathering insurance provider data in the tangible computer medium from the plurality of External Data Providers;
e. gathering pharmacy data in the tangible computer medium from the plurality of External Data Providers;
f. Transmitting the prescription and the Patient data to a computer system;
g. Analyzing the prescription and Patient data by the computer system for the cost components and cost offsets; and
h. Applying an algorithm by the computer system to the cost components and cost offsets of the prescription and Patient data to estimate the best price that the Patient will pay at the Pharmacy.

2. The method as defined in claim 1, wherein the prescription is previously entered into an Electronic Medical Records (“EMR”) system by the Physician or an agent of the Physician and wherein the step of gathering the prescription in the tangible computer medium is performed by a software add-in program to the Physician EMR system.

3. The method as defined in claim 1, wherein the Patient data is previously entered into the Physician's EMR system by the Physician or an agent of the Physician and wherein the step of gathering Patient data in the tangible computer medium is performed by a software add-in program to the Physician EMR system.

4. The method as defined in claim 1, wherein the computer system is a computer and a database connected to each other and to the Physician EMR system via a private network, wherein the computer and database comprising the computer system is a physical or virtualized system and wherein the computer and database that comprise the system is hosted on predetermined premises and accessed by the private network or hosted by third party providers and accessed via the Internet or the cloud.

5. The method as defined in claim 4, wherein the database in the computer system is further subdivided into role-specific, logical databases consisting of a Medicine Database, an Insurance Database, and a Pharmacy Database.

6. The method as defined in claim 1, wherein the tangible computer medium database is in the form of the Extensible Markup Language or the JavaScript Object Notation.

7. The method as defined in claim 1, wherein the step of transmitting the prescription and Patient data to the computer system is performed using the Hypertext Transfer Protocol.

8. The method as defined in claim 1, wherein the step of gathering medicine data from the External Data Providers is performed by the computer system.

9. The method as defined in claim 8, wherein the medicine data gathered from the External Data Providers is stored in a Medicine Database and wherein the medicine data gathered from the External Data Providers and stored in the Medicine Database may be updated or removed by the computer system on an interval specified by each of the External Data Providers.

10. The method as defined in claim 9, wherein the medicine data gathered from the External Data Providers consists of the medicine manufacturer brand name of the medicine, the generic name of the medicine, the common names of the medicine, the drug class of the medicine, other medicines which may be used as substitutes, the common ways that the medication is taken, and the commonly prescribed dosage amounts for the medicine, and the list price for the medication as provided by the manufacturer.

11. The method as defined in claim 10, wherein the External Data Provider consists of the plurality of pharmaceutical providers, pharmacy benefit management providers, pharmaceutical clearinghouse providers, and independent providers of medicine data.

12. The method as defined in claim 1, wherein the step of gathering insurance provider data from the plurality of External Data Providers is performed by the computer system.

13. The method as defined in claim 12, wherein the insurance provider data gathered from the External Data Providers is stored in the Insurance Database and wherein the insurance provider data gathered from the External Data Providers and stored in the Insurance Database may be updated or removed by the computer system on an interval specified by each of the External Data Providers.

14. The method as defined in claim 13, wherein the insurance provider data gathered from the External Data Providers consists of the legal name of the insurance provider, the common names of the insurance provider, the insurance plans provided by the insurance provider, the prescription drug benefits provided by the insurance plans, and the drug formularies for the prescription drug benefits.

15. The method as defined in claim 14, wherein the External Data Provider consists of the plurality of insurance providers, pharmacy benefit management providers, pharmaceutical clearinghouse providers, and independent providers of medicine data.

16. The method as defined in claim 1, wherein the step of gathering pharmacy data from the plurality of External Data Providers is performed by the computer system.

17. The method as defined in claim 16, wherein the pharmacy data gathered from the External Data Providers is stored in the Pharmacy Database and wherein the pharmacy data gathered from the External Data Providers and stored in the Pharmacy Database is updated or removed by the computer system on an interval specified by each of the External Data Providers.

18. The method as defined in claim 17, wherein the pharmacy data gathered from the External Data Providers consists of the legal name of the pharmacy, the location of the pharmacy, the contact information for the pharmacy, the retail, cash price for the medicines in the Medicine Database at the pharmacy, the insurance plans honored by the pharmacy, and promotional pricing for all medicines in the Medicine Database.

19. The method as defined in claim 18, wherein the External Data Provider consists of the plurality of pharmacies, pharmacy benefit management providers, pharmaceutical clearinghouse providers, and independent providers of medicine data.

20. The method as defined in claim 1, wherein the step that analyzes the prescription and Patient data for cost components is comprised of deconstructing the prescription to determine the medicines that comprise the prescription, the dosages of the medications, the way the Physician prescribed that the Patient take the medicine, and the frequency with which the Physician prescribed that the Patient take the medicine.

21. The method as defined in claim 1, wherein the step that analyzes the prescription and Patient data for cost offsets is comprised of deconstructing the Patient data for an insurance provider, an insurance plan, the Patient preferred pharmacy or plurality of preferred pharmacies, and other pharmacies within the local area of the Patient and the Patient's physician.

22. The method as defined in claim 21, wherein pharmacies within the local area are determined by geo-location based on the Patient current location, the Patient home address, and the Physician office address.

23. The method as defined in claim 22, wherein the Patient current location and the Patient home address are provided by a software application installed by the Patient on a Patient User Device.

24. The method as defined in claim 22, wherein the Patient home address and the Physician office address are provided by the software add-in program to the Physician EMR system.

25. The method as defined in claim 1, wherein the step that applies the algorithm to the cost components and cost offsets of the prescription and Patient data to estimate the price of the prescription consists of the plurality of data lookups in the Medicine, Insurance, and Pharmacy databases, a comparison of the results of the lookups to determine the price of each medicine that comprises the prescription, the pharmacies providing those medications, both and collectively, at the lowest price, and the summation and summarization of these results.

26. The method as defined in claim 25, wherein an estimated price of any medicine that comprises the prescription is calculated by the computer system using price estimation algorithms if one, any, or all of the data necessary to conclusively determine the price of the medicine is missing or otherwise unavailable in the Medicine, Insurance, and Pharmacy databases.

27. The method as defined in claim 26, the data in the Medicine, Insurance, and Pharmacy accessed by the price estimation algorithms represents datum from a single point in time, an irregular collection of data from various points in time, or a time-series of data collected at regular intervals.

28. The method as defined in claim 1, wherein the Physician accesses the software add-in program to the Physician EMR system using the Physician User Device.

29. The method as defined in claim 1, wherein some of the data about the Patient is entered into a software application on a Patient User Device by the Patient and is stored on the Patient User Device in the tangible computer medium.

29. The method as defined in claim 29, wherein the data about the Patient is transmitted by the software application on the Patient User Device over the Computer Network to the software add-in program to the Physician's EMR system.

30. The method as defined in claim 30, wherein the data transmitted by the software application on the Patient User Device to the software add-in program to the Physician's EMR is encrypted.

31. The method as defined in claim 30, wherein the data transmission between the software application on the Patient User Device and the software add-in program to the Physician's EMR system is initiated by the Patient.

32. The method as defined in claim 30, wherein the data about the Patient is transmitted to the Physician EMR system by the software add-in program to the Physician EMR system over a Computer Network.

33. The method as defined in claim 33, wherein the data about the Patient transmitted between the software add-in program to the Physician EMR system and the Physician EMR system is encrypted.

34. The method as defined in claim 33, wherein the data about the Patient transmitted between the software add-in to the Physician EMR system and the Physician EMR system is permanently retained by the Physician EMR system.

35. The method as defined in claim 29, wherein the data about the Patient may contain patient-identifiable information.

36. The method as defined in claim 29, wherein some of the data about the Patient may have been entered into the software application on the Patient User Device by sensors contained within the Patient User Device or by other software applications installed on the Patient User Device for the purpose of collecting data about the Patient's health.

37. The method as defined in claim 29, wherein data about the Patient's prescription is transmitted from the software add-in to the Physician's EMR system to the software application on the Patient User Device.

38. The method as defined in claim 29, wherein some of the Patient data contains data about the Patient's prescription previously transmitted from the software add-in to the Physician's EMR system as defined in claim 38.

39. The method as defined in claim 29, wherein some of the Patient data contains data from an External Data Provider.

40. The method as defined in claim 40, wherein the connection between the software application on the Patient User Device and the External Data Provider occurs over a Computer Network.

41. The method as defined in claim 41, wherein the connection between the software application on the Patient User Device and the External Data Provider is private and unique to that Patient User Device.

42. The method as defined in claim 29, wherein the Patient can view the Patient data on the screen of the Patient User Device and can edit some Patient data using the Patient User Device.

43. The method as defined in claim 29, wherein the software application on the Patient User Device will alert the Patient using the standard alert and notification mechanisms on the Patient User Device when important actions are required by the Patient with regard to a prescription.

44. The method as defined in claim 44, wherein the important actions of the Patient consist of prior authorizations, prescription refills, acknowledgment of price changes for the Patient's current prescription, and notification of changes in the formulary of the Patient's insurance plan.

45. A system for estimating a best price Physician prescription at a local Patient Pharmacy, comprising:
a. a tangible computer medium for storing the prescription from a Physician;
b. patient data stored in the tangible computer medium;
c. medicine data stored in the tangible computer medium from a plurality of External Data Providers;
d. insurance provider data stored in the tangible computer medium from the plurality of External Data Providers;
e. pharmacy data stored in the tangible computer medium from the plurality of External Data Providers;
f. wherein the prescription and the Patient data is combined and sent to a computer system;
g. wherein the prescription and Patient data is analyzed by the computer system for cost components and cost offsets; and
h. wherein the computer system utilizes an algorithm to provide the cost components and cost offsets for the prescription and Patient data to estimate the best price break for the Patient prescription at the Pharmacy.
